(19) United States
(12) Patent Application Publication
(10) Pub. No.: US 2020/0372617 A1
(43) Pub. Date: Nov. 26, 2020

(54) ROBUST METHODS FOR DEEP IMAGE TRANSFORMATION, INTEGRATION AND PREDICTION

(71) Applicant: DRVision Technologies LLC, Bellevue, WA (US)

(72) Inventors: Hideki Sasaki, Bellevue, WA (US); Chi-Chou Huang, Redmond, WA (US); Luciano Andre Guerreiro Lucas, Redmond, WA (US); Shih-Jong James Lee, Bellevue, WA (US)

(21) Appl. No.: 16/990,848

(22) Filed: Aug. 11, 2020

Related U.S. Application Data
(62) Division of application No. 16/010,597, filed on Jun. 18, 2018.

(51) Int. Cl. G06T 5/00; G06N 20/00

(52) U.S. Cl. CPC G06T 5/003; G06T 2207/20081; G06N 20/00; G06T 5/002

(57) ABSTRACT

A computerized robust deep image transformation method performs a deep image transformation learning on multi-variation training images and corresponding desired outcome images to generate a deep image transformation model, which is applied to transform an input image to an image of higher quality mimicking a desired outcome image. A computerized robust training method for deep image prediction performs a deep image prediction learning on universal modality training images and corresponding desired modality prediction images to generate a deep image prediction model, which is applied to transform universal modality images into a high quality image mimicking a desired modality prediction image.

### CROSS REFERENCE TO RELATED APPLICATIONS

The present application is a division of prior U.S. application Ser. No. 16/010,597 filed Jun. 18, 2018, now pending. The entirety of said prior application is incorporated herein by reference.

### STATEMENT AS TO RIGHTS TO INVENTIONS MADE UNDER FEDERALLY SPONSORED RESEARCH AND DEVELOPMENT

This work was supported by U.S. Government grant number 4R44NS097094-02, awarded by the NATIONAL INSTITUTE OF NEUROLOGICAL DISORDERS AND STROKE. The U.S. Government may have certain rights in the invention.

### BACKGROUND OF THE INVENTION

### Field of the Invention

The present invention relates to image processing and restoration. More particularly, the present invention relates to computerized deep image transformation, integration and prediction methods using deep image machine learning.

### Description of the Related Art

Image restoration is the operation of taking a corrupt/noisy image and estimating the clean, original image. Corruption may come in many forms such as motion blur, noise and camera de-focus. Prior art image processing techniques are performed either in the image domain or the frequency domain for image restoration. The most straightforward prior art technique for image restoration is deconvolution, which is performed in the frequency domain and after computing the Fourier transform of both the image and the Point Spread Function (PSF) and undoing the resolution loss caused by the blurring factors. This deconvolution technique, because of its direct inversion of the PSF which typically has poor matrix condition number, amplifies noise and creates an imperfect deblurred image. Also, conventionally the blurring process is assumed to be shift-invariant. Hence more sophisticated techniques, such as regularized deblurring, have been developed to offer robust recovery under different types of noises and blurring functions. But the prior art performance has not been satisfactory especially when the PSF is unknown. It is highly desirable to have robust image restoration methods.

Machine learning, especially deep learning, powered by the tremendous computational advancement (GPUs) and the availability of big data has gained significant attention and is being applied to many new fields and applications. Deep convolutional networks have swept the field of computer vision and have produced stellar results on various recognition benchmarks. Recently, deep learning methods are also becoming a popular choice to solve low-level vision tasks in image restoration with exciting results.

A learning-based approach to image restoration enjoys the convenience of being able to self-generate training instances based on the original real images. The original image itself is the ground-truth the system learns to recover. While existing methods take advantage of this convenience, they inherit the limitations of real images. So the results are limited to the best possible imaging performance.

Furthermore, the norm in existing deep learning methods is to train a model that succeeds at restoring images exhibiting a particular level of corruption. The implicit assumption is that at application time, either corruption will be limited to the same level or some other process will estimate the corruption level before passing the image to the appropriate, separately trained restoration system. Unfortunately, these are strong assumptions that remain difficult to meet in practice. As a result, existing methods risk training fixated models: models that perform well only at a particular level of corruption. That is, deep networks can severely over-fit to a certain degree of corruption.

### BRIEF SUMMARY OF THE INVENTION

The primary objective of this invention is to provide a robust method for computerized robust deep image transformation through machine learning. The secondary objective of the invention is to provide a computerized robust deep image integration method through machine learning. The third objective of the invention is to provide a computerized deep image prediction method through machine learning. The primary advantage of the invention is to have deep models that convert input image into exceptional image outcomes that no imaging systems could have produced.

In the present invention, deep model is learned with training images acquired from a control range that captured the expected variations so the deep model can be sufficiently trained with robust performance. To overcome the limitation to the best possible imaging as truth, the present invention introduces flexible truth that creates ideal images by additional enhancement, manual editing or simulation. This way, the deep model could generate images that outperform the best possible conventional imaging systems. Furthermore, the present invention generalizes the flexible truth to allow deep learning models to integrate images of different modalities into an ideal integrated image that cannot be generated by conventional imaging systems. In addition, the present invention also generalizes the flexible truth to allow the prediction of special image modality from universal modality images. These offer a great advantage over prior art methods and can provide exceptional image outcomes.

### BRIEF DESCRIPTION OF THE DRAWINGS

FIG. 1 shows the processing flow of the computerized robust deep image transformation method.

FIG. 2 shows the processing flow of the application the deep image transformation model to an input image.

FIG. 3 shows the processing flow of the computerized robust deep image integration method.

FIG. 4 shows the processing flow of the application the deep image integration model to an input image.

FIG. 5 shows the processing flow of the computerized robust deep image prediction method.

FIG. 6 shows the processing flow of the application the deep image prediction model to an input image.

### DETAILED DESCRIPTION OF THE PREFERRED EMBODIMENTS

The concepts and the preferred embodiments of the present invention will be described in detail below in conjunction with the accompanying drawings.

### I. Computerized Robust Deep Image Transformation

FIG. 1 shows the processing flow of the computerized robust deep image transformation method of the present invention. A plurality of multi-variation training images 100, 102, 104 and the corresponding desired outcome images 106, 108, 110 are entered into electronic storage means and a deep image transformation learning 112 is performed by electronic computing means using the multi-variation training images 100, 102, 104 and the corresponding desired outcome images 106, 108, 110 as truth data to generate and output a deep image transformation model 114.

In one embodiment of the invention, the multi-variation training images 100, 102, 104 contain a set of images acquired with controlled variations. The images can be 2D, 3D, 3D+time, and/or 3D+channels+time, etc. The images with controlled variations can be acquired from an imaging system adjusted for a range of expected variations. In this embodiment, images with different quality levels are acquired using the same imaging system under different imaging conditions such as illumination level, camera gain, exposure time or a plurality of imaging settings. In another embodiment, different imaging systems with different configurations or settings for controlled variations can be used to acquire the multi-variation training images.

The desired outcome image for a training image is a high quality (such as low noise, distortion, degradation, variations and high contrast, etc) image of the same sample. This could be acquired from an ideal imaging system that achieves the best possible image quality or the same imaging system or a similar imaging system but with desired image quality setting such as long exposure time, uniform illumination. It is also possible to create the desired outcome images by simulation of the sample or by editing, resolution enhancement or de-noising of the acquired images using specially designed algorithms or manually.

In the deep image transformation learning 112, the multi-variation training images 100, 102, 104 are used as training images, while the corresponding desired outcome images 106, 108, 110 are used as ground truth for the learning process. If the training images and their corresponding desired outcome images are not aligned or not of the same scale, the deep image transformation learning step 112 will also perform image scaling and alignment to assure point to point correspondence between a training image and its ground truth image that is derived from its corresponding desired outcome image. Through the deep image transformation learning 112, a deep image transformation model 114 is generated.

In one embodiment of the invention, the deep image transformation model 114 is an encoder-decoder network. The encoder takes an input image and generates a high-dimensional feature vector with aggregated features at multiple levels. The decoder decodes features aggregated by the encoder at multiple levels and generates a semantic segmentation mask. Typical encoder-decoder networks include U-Net and its variations such as U-Net+Residual blocks, U-Net+Dense blocks, 3D-UNet. The model can be extended to recurrent neural networks for applications such as language translation, speech recognition, etc.

In one embodiment of the invention, the deep image transformation learning 112 is through an iterative process that gradually minimizes the loss function at the output layer by adjusting weights/parameters (Θ) at each layer of the model using a back propagation method. The loss function is usually the sum of squared differences between the ground truth data L(x) and the model output p(I(x), Θ) for all points of the image I(x) where x is the multi-dimensional indices of image points.

In another embodiment of the invention, to improve the robustness of the deep image transformation model 114 and to handle all different image variation levels, the intermediate deep image transformation model generated at the end of a training iteration will be used to validate a small set of training images from each of the image variation levels. More representative training images from the image variation levels with poor performance will be used for training in the next iteration. This approach is to force the deep image transformation model 114 to be trained with more varieties of difficult cases through self-guided training process, and to gradually increase the robustness for handling broader image variation ranges.

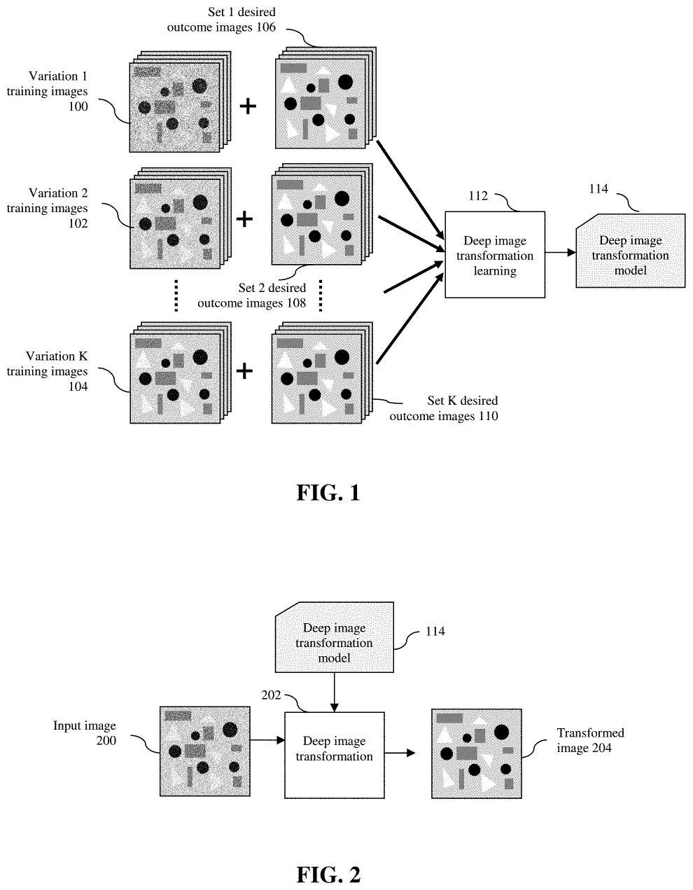

The deep image transformation model 114 is learned to transform a low quality image with variation into a high quality image that mimics a desired outcome image. FIG. 2 shows the processing flow of the application of the deep image transformation model 114 to an input image 200 with variation and/or image quality degradation. The deep image transformation step 202 loads a trained deep image transformation model 114 and applies the model to transform the input image 200 into a transformed image 204 that mimics the desired outcome image for the input image 200. For good performance, the input image 200 should be acquired using the same or similar imaging system with image variations close to the range in the plurality of multi-variation training images 100, 102, 104.

### II. Computerized Robust Deep Image Integration

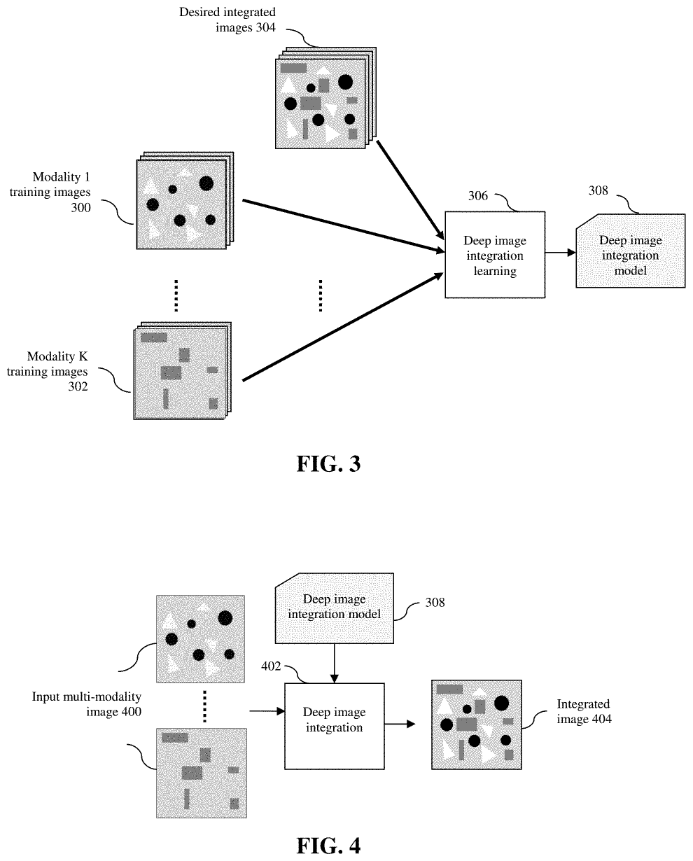

FIG. 3 shows the processing flow of the computerized robust deep image integration method of the present invention. A plurality of multi-modality training images 300, 302 and their corresponding desired integrated images 304 are entered into electronic storage means and a deep image integration learning 306 is performed by electronic computing means using the multi-modality training images 300, 302 and the corresponding desired integrated images 304 as truth data to generate and output a deep image integration model 308.

In one embodiment of the invention, the multi-modality training images 300, 302 contain a set of images acquired from a plurality of imaging modalities. The images can be 2D, 3D and 3D+time, etc. The images with a plurality of imaging modalities can be acquired from an imaging system set up for different modalities wherein different imaging modalities highlight different components/features of the sample.

Some modalities may highlight a same component (e.g. mitochondria) or features but with different image quality, resolution and noise levels. In a microscopy imaging application embodiment, the imaging modalities could represent different microscope types such as confocal, Structured Illumination Microscopy (SIM), location based single molecule microscope (e.g. PALM, STORM) or light sheet microscope, etc. Furthermore, fluorescence microscopes can image samples labeled by different fluorescence probes and/or antibodies, each highlighting different components or the same component (e.g. microtubules) in slightly different ways (e.g. more punctated vs. more continuous). They can be considered images of different modalities.

One desired integrated image is common for images from different modalities of the same sample. It is intended to be of high quality and integrated information contained in different image modalities. This could be acquired or derived from an ideal imaging system that achieves the best possible image integration by combining images from different modalities using ideal combination algorithm, or by manual processing. It is also possible to create the desired integrated images by simulation of the sample or by editing, resolution enhancement or de-noising of the acquired images by specially designed algorithms or manually.

In the deep image integration learning 306, the multi-modality training images 300, 302 are used as training images, while the corresponding desired integrated images 304 are used as ground truth for the learning. If the training images and their corresponding desired integrated images are not aligned or not of the same scale, the deep image integration learning 306 will perform image scaling and alignment to assure point to point correspondence between the multi-modality training image and its ground truth image that is derived from its corresponding desired integrated image. Through the deep image integration learning 306, a deep image integration model 308 is generated.

In one embodiment of the invention, the deep image integration model 308 is an encoder-decoder network. The encoder takes an input image and generates a high-dimensional feature vector with aggregated features at multiple levels. The decoder decodes features aggregated by the encoder at multiple levels and generates a semantic segmentation mask. Typical encoder-decoder networks include U-Net and its variations such as U-Net+Residual blocks, U-Net+Dense blocks, 3D-UNet. The model can be extended to recurrent neural networks for applications such as language translation, speech recognition, etc.

In one embodiment of the invention, the deep image integration learning 306 is through an iterative process that gradually minimizes the loss function at the output layer by adjusting weights/parameters (Θ) at each layer of the model using a back propagation method. The loss function is usually the sum of squared differences between the ground truth data L(x) and the model output p(I(x), Θ) for all points of the image I(x).

In another embodiment of the invention, to improve the robustness of the deep image integration model 308 to handle all different image modalities, the intermediate deep image integration model generated at the end of a training iteration will be used to validate a small set of training images from each of the image modalities. More representative training images from the image modalities with poor performance will be used for training in the next iteration. This approach is to force the deep image integration model 308 to be trained with more varieties of difficult cases through self-guided training process, and to gradually increase the robustness for handling different image modalities.

The deep image integration model 308 is learned to transform multi-modality images into a high quality integrated image that mimics a desired integrated image. FIG. 4 shows the processing flow of the application of the deep image integration model 308 to an input multi-modality image 400. The deep image integration step 402 loads a trained deep image integration model 308 and applies the model to integrate the input multi-modality image 400 into an integrated image 404 that mimics the desired integrated image corresponding to the input multi-modality image 400. For good performance, the input multi-modality image 400 should be acquired using the same or similar imaging systems of multiple modalities close to the plurality of multi-modality training images 300, 302.

### III. Computerized Robust Deep Image Prediction

FIG. 5 shows the processing flow of the computerized robust deep image prediction method of the present invention. A plurality of universal modality training images 500 and their corresponding desired modality prediction images 502 are entered into electronic storage means and a deep image prediction learning 504 is performed by computing means using the universal modality training images 500 and the corresponding desired modality prediction images 502 as truth data to generate and output a deep image prediction model 506.

In one embodiment of the invention, the universal modality training images 500 contain a set of images acquired from a universal imaging modality that detects most of the features in a sample but with limited contrast and image quality. The images can be 2D, 3D and 3D+time, etc. In one embodiment of the microscopy imaging applications, the universal modality images are acquired from label free imaging system such as phase contrast microscopy, differential interference contrast (DIC) microscopy and digital holographic microscopy, etc.

The desired modality prediction images are images from an imaging modality of interest that may highlight certain components of the sample such as nuclei, cytosol, mitochondria, cytoskeleton, etc. The desired modality prediction images are intended to be of high quality with the ideal modality highlighting the desired components and/or features. They can be acquired from the same sample as the universal modality training images but with special probes and imaging system to enhance the desired modality. It is also possible to create the desired predicted images by simulation for the sample or by editing, resolution enhancement or de-noising of the acquired images using specially designed algorithms or manually.

In the deep image prediction learning 504, the universal modality training images 500 are used as training images, while the corresponding desired modality prediction images 502 are used as ground truth for the learning. If the training images and their corresponding desired modality prediction images are not aligned or not of the same scale, the deep image prediction learning 504 will perform image scaling and alignment to assure point to point correspondence between the universal modality training image and its ground truth image that is derived from its corresponding desired modality prediction image. Through the deep image prediction learning 504, a deep image prediction model 506 is generated.

In one embodiment of the invention, the deep image prediction model 506 is an encoder-decoder network. The encoder takes an input image and generates a high-dimensional feature vector with aggregated features at multiple levels. The decoder decodes features aggregated by the encoder at multiple levels and generates a semantic segmentation mask. Typical encoder-decoder networks include U-Net and its variations such as U-Net+Residual blocks, U-Net+Dense blocks, 3D-UNet. The model can be extended to recurrent neural networks for applications such as language translation, speech recognition, etc.

In one embodiment of the invention, the deep image prediction learning 504 is through an iterative process that gradually minimizes the loss function at the output layer by adjusting weights/parameters (Θ) at each layer of the model using a back propagation method. The loss function is usually the sum of squared differences between the ground truth data L(x) and the model output p(I(x), Θ) for all points of the image I(x).

In another embodiment of the invention, to improve the robustness of the deep image prediction model 506 to handle different variations of the universal modality training images 500, the intermediate deep image prediction model generated at the end of a training iteration will be used to validate a small set of training images. More representative training images with poor performance will be used for training in the next iteration. This approach is to force the deep image prediction model 506 to be trained with more varieties of difficult cases through self-guided training process, and to gradually increase the robustness for handling different image variations.

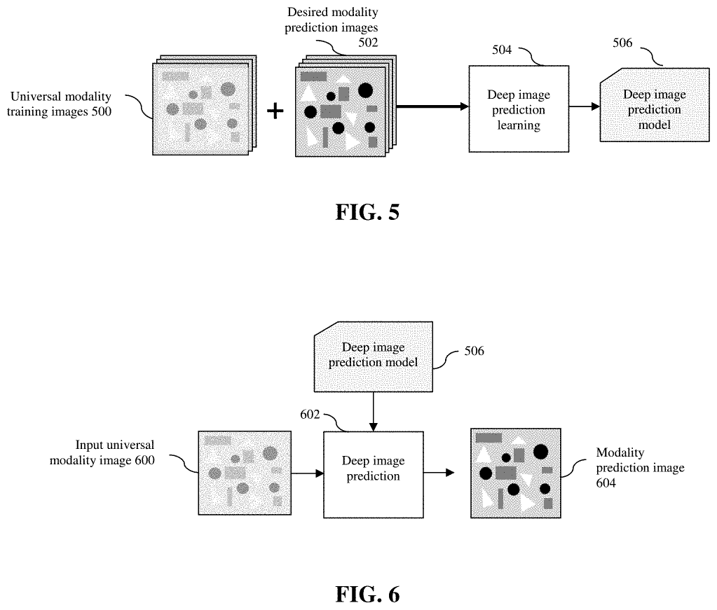

The deep image prediction model 506 is learned to transform universal modality images into a high quality image that mimics a desired modality prediction image. FIG. 6 shows the processing flow of the application of the deep image prediction model 506 to an input universal modality image 600. The deep image prediction step 602 loads a trained deep image prediction model 506 and applies the model to the input universal modality image 600 to generate a modality prediction image 604 that mimics a desired modality prediction image corresponding to the input universal modality image 600. For good performance, the input universal modality image 600 should be acquired using the same or similar imaging systems for the plurality of universal modality training images 600.

The invention has been described herein in considerable detail in order to comply with the Patent Statutes and to provide those skilled in the art with the information needed to apply the novel principles and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. A computerized robust training method for deep image prediction, comprising the steps of:
a) inputting a plurality of universal modality training images and corresponding desired modality prediction images into electronic storage means; and
b) performing a deep image prediction learning by electronic computing means using the plurality of universal modality training images and the corresponding desired modality prediction images as truth data to generate a deep image prediction model.

2. The computerized robust training method for deep image prediction of claim 1, wherein the deep image prediction model predicts at least one desired modality prediction image from an input universal modality image.

3. The computerized robust training method for deep image prediction of claim 1, wherein the deep image prediction model is an encoder-decoder network.

4. The computerized robust training method for deep image prediction of claim 1, wherein the desired modality prediction images are acquired from an imaging system of a desired modality.

5. The computerized robust training method for deep image prediction of claim 1, wherein the desired modality prediction images are created by simulation.

6. The computerized robust training method for deep image prediction of claim 1, wherein the plurality of universal modality training images are acquired from a label free imaging system.
